(19) United States
(12) Patent Application Publication
(10) Pub. No.: US 2013/0253951 A1
(43) Pub. Date: Sep. 26, 2013

(54) METHOD, SYSTEM, AND APPARATUS FOR TABLET BASED HEALTHCARE COMMUNICATION

(71) Applicant: CIPHERHEALTH, LLC, New York, NY (US)

(72) Inventors: Stephan Richter, Maynard, MA (US); Roy Mathew, Miami, FL (US); Zachary Silverzweig, New York, NY (US)

(73) Assignee: CipherHealth, LLC, New York, NY (US)

(21) Appl. No.: 13/804,943

(22) Filed: Mar. 14, 2013

Related U.S. Application Data
(60) Provisional application No. 61/613,675, filed on Mar. 21, 2012.

(51) Int. Cl. G06F 19/00

(52) U.S. Cl. CPC G06F 19/3418
USPC 705/3; 705/2

(57) ABSTRACT

In some embodiments, a system includes a server, a patient device, and a caregiver device. The patient device is associated with a patient and is configured to communicate with the server. The patient device is configured to send signals of various urgency to the server. The server can prioritize a caregivers workflow and send a list of tasks to the caregiver via the caregiver device. The order of the list of tasks can be based, at least in part, on the urgency of a signal sent by the patient device.

### CROSS REFERENCE TO RELATED APPLICATION

This application claims priority to U.S. Patent Application No. 61/613,675 entitled “Tablet Based Healthcare Communication System,” filed Mar. 21, 2012, which is incorporated herein by reference in its entirety.

### BACKGROUND

Some embodiments described herein relate to a tablet based healthcare communication system, which can include a patient device, a server, and/or a healthcare provider device. The tablet based healthcare communication system can provide data (e.g., patient information, information on the care giving team, messages from the care giving team, patient condition, patient requests, results of medical tests, meal orders, media and gaming content, doctor recommendations, treatment plans, disease fact sheets, etc.) to, for example, a patient and/or a healthcare provider.

Traditionally, patients interact with caregivers and/or other hospital employees either in person, or by using a paging system, e.g., a call button. For example, using some known systems, a patient may page a caregiver for any number of reasons, ranging from a desire for conversation to requiring attention for a life threatening medical emergency. Some known paging systems may be unable to distinguish between or prioritize routine patient requests and emergency requests.

Furthermore, caregivers traditionally communicate with patients either orally or by providing hardcopy printed material. When caregivers communicate with patients orally and/or verbally, the patient may not remember the details of the conversation. When caregivers communicate with patients via hardcopy printed material, the patient may have difficulty locating a particular piece of information of interest.

Accordingly, a need exists for tablet based communication in a healthcare setting (e.g., hospital, home, etc.).

### SUMMARY

In some embodiments, a system includes a server, a patient device, and a caregiver device. The patient device is associated with a patient and is configured to communicate with the server. The patient device is configured to send signals of various urgency to the server. The server can prioritize a caregivers workflow and send a list of tasks to the caregiver via the caregiver device. The order of the list of tasks can be based, at least in part, on the urgency of a signal sent by the patient device.

### BRIEF DESCRIPTION OF THE DRAWINGS

FIG. 1 is a schematic of a healthcare communication system, according to an embodiment.

FIGS. 2 and 3 are screenshots of instances of a graphical user interface (GUI) of a patient device.

FIG. 4 is a method of operating a patient device of a healthcare communication system, according to an embodiment.

FIG. 5 is a method of operating a server of a healthcare communication system, according to an embodiment.

### DETAILED DESCRIPTION

The embodiments described herein relate to systems, methods, and apparatus for tablet based healthcare communication. In one embodiment, a system includes a server, a patient device, and a caregiver device. The patient device can be configured to send signals to the server. The server can prioritize a list of tasks for the caregiver based, at least in part on an urgency associated with the signal sent by the patient device. For example, the patient device can be operable to send different signals associated with different urgencies. The server can send a prioritized task list to the caregiver device.

In another embodiment, an apparatus includes non-transitory processor-readable medium that includes code to cause a processor on a patient device to register with a server. The code can further include code to cause the patent device to send requests for medical attention to the server. For example, the patient device can be operable to receive a first input (e.g., from a patient) requesting medical attention and can, in response send a signal requesting the medical attention to the server. In response, the patient device can receive a signal acknowledging the request and an indication of an expected time in which medical attention will be provided. The requests for medical attention can include an indication of the type of medical attention requested. The server can be operable to assign an appropriate caregiver based on the type of medical attention requested. Similarly stated, in response to receiving a first request for medical attention, the server can assign a first caregiver and can send a signal to the patient device indicating the assigned caregiver and/or an expected response time. In a similar fashion, the patient device can be operable to request a second type of medical attention, the server can assign a second caregiver, and the server can send a signal to the patient device indicating the assigned caregiver and/or an expected response time. The server can also be operable to send a signal to the assigned caregiver, which can include instructions to respond to the patient request.

In another embodiment, an apparatus includes a non-transitory processor-readable medium that includes code to cause a processor on a server to register one or more patient devices. A patient device, as described in further detail herein, can be a personal computing entity, such as a tablet, and can be provided at the bedside of an admitted patient in a healthcare setting. The code can further include code to cause the server to define an association between the patient device and a medical record of the patient. The server can receive requests for medical attention from patient devices. The code can include code to cause the server to prioritize requests received from patient devices based, at least in part, on the medical record of the patient sending the requests and send a prioritized requests to a healthcare provider.

In one embodiment, an apparatus includes involving a non-transitory processor-readable medium that includes code to cause a processor on a patient device to receive a first set of items involving patient information, information on the care giving team, messages from the care giving team, and/or the like. The code can include code to cause the patient device to send, to a server, a second set of items involving information on patient condition, patient requests, results of medical tests, meal orders, and/or the like. The code can further include code to cause the patient device to receive a third set of items involving media and gaming content, doctor recommendations, treatment plans, disease fact sheets, and/or the like.

The patient device can, in some embodiments improve communication between a patient and his healthcare provider, improve care outcomes through interactive patient education, increase efficiency by helping the healthcare providers prioritize their activity, and improve the patient's healthcare setting experience with media and gaming content. A communication system can lead to a patient driven care optimization system that can connect patients directly to the healthcare setting, and centralize patient management and improve the quality and efficiency of the care delivered.

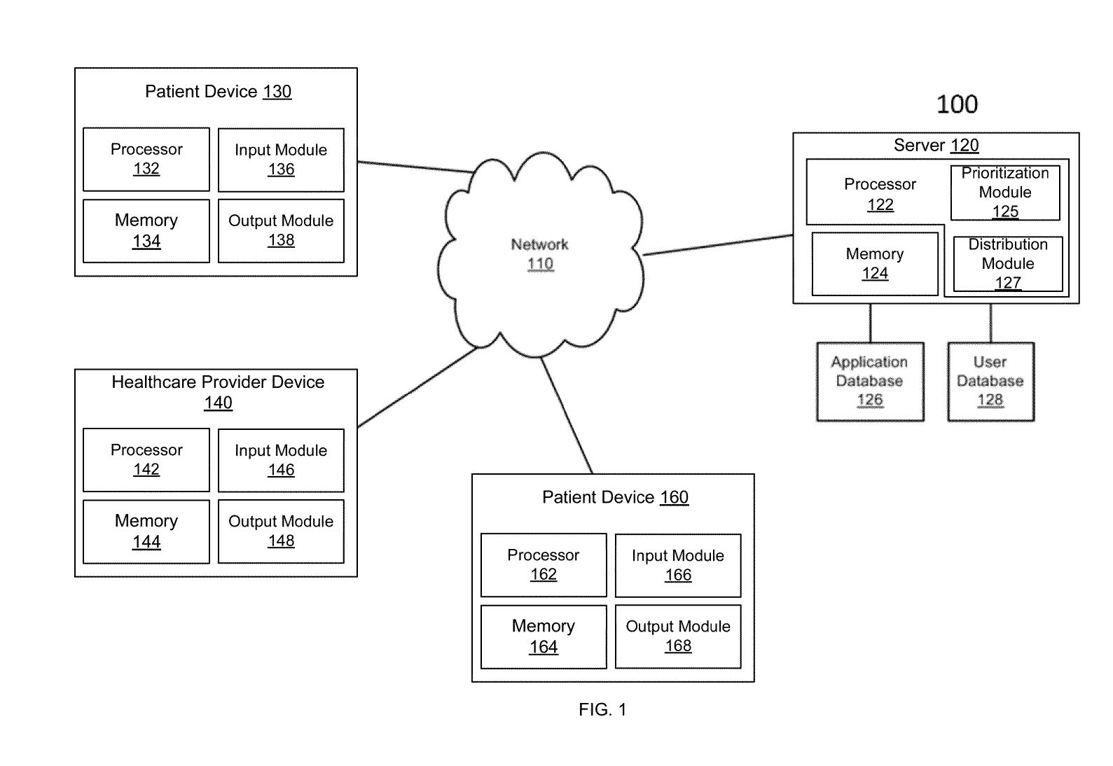

FIG. 1 is a schematic of the healthcare communication system 100. The healthcare communication system 100 includes a first patient device 130, a second patient device 160, a healthcare provider device 140, and a server 120. The first patient device 130, the second patient device 160, the healthcare provider device 140, and the server 120 are all communicatively coupled via a network 110.

The first patient device 130 can be any communication device, such as, for example, a touch-screen tablet, a small laptop, a personal digital assistant (PDA), a mobile telephone (e.g., a smart phone), a tablet personal computer (PC), and/or the like. The first patient device 130 includes a processor 132, a memory 134, an input device 136, and a display 138.

The first patient device 130 can be operable to send and/or receive signals via the network 110. The network 110 can be any type of network (e.g., the Internet, an intranet, a local area network (LAN), a wide area network (WAN), a virtual network, a telecommunications network) implemented as a wired network and/or wireless network. For example, the patient device 130 can send signals, such as a request for medical attention, which may include an indication of the urgency of the request. The patient device 130 can also be operable to send and/or receive information, e.g. to and/or from the server 120 and/or the provider device 140. For example, the patient device 130 can send and/or receive information related to patient condition, patient requests, results of medical tests, meal orders, information on the care giving team, media and gaming content, etc. The patient device 130 can also be operable to receive information from the server, such as doctor recommendations, treatment plans, disease fact sheets, messages from the care giving team, etc.

In some embodiments, the patient device 130 can be used by the patient to communicate with hospital staff, including caregivers. The patient device 130 can be used to send signals requesting various types of attention, for example, the patient device can send signals to request attention from a caregiver, request attention from a hospitality staff member, etc. For example, the patient can make requests, such as a request for assistance to take a walk, a request for lunch, a request for assistance to use the restroom, a request for medical assistance with pain, a request for a response to a medical emergency, etc. In some embodiments, the patient device 130 and/or the server 120 can assign priorities to requests. In some embodiments, the patient may be able to indicate an urgency of a request.

The processor 132 can be a general purpose processor, a Field Programmable Gate Array (FPGA), an Application Specific Integrated Circuit (ASIC), a Digital Signal Processor (DSP), and/or the like. In some embodiments, the first patient device 130 can include one or more hardware-based modules (e.g., DSP, FPGA, ASIC) and/or software-based modules (e.g., a module of computer code stored in a memory, e.g., the memory 134, to be executed at a processor, e.g., the processor 132, a set of processor-readable instructions that can be executed at a processor, e.g., the processor 132) associated with executing an application, such as, for example, an application operable to communicate with the server 120 via the network 110.

The processor 132 can be configured to retrieve data from and/or write data to the memory 134. The memory 134 can be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, and/or so forth.

The input module 136 can be, for example, a keyboard, a mouse, a touch screen, a microphone and/or the like. The input module 136 can be operable to enable a user (e.g., a patient) to interact with the patient device 130, for example, to direct the patient device 130 to send a signal to the server 120.

The output module 138 can be a television, a liquid crystal display (LCD) monitor, a cathode ray tube (CRT) monitor, speaker, tactile output device, and/or the like. In some embodiments, the output module 138 can be an integral component of the communication device 120. Similarly stated, the output module 138 can be directly coupled to the processor 132. For example, the output module 138 can be the integral display of a tablet and/or smart phone. In some embodiments, the output module can include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector.

The second patient device 160 can be structurally and/or functionally similar to the first patient device 130. The second patient device 160 includes a processor 162, a memory 164, an input device 166, and an output module 168, each of which can be structurally and/or functionally similar to the processor 132, the memory 134, the input device 136, and the output module 138, respectively.

The server 120 can be, for example, a web server, an application server, a proxy server, a telnet server, a file transfer protocol (FTP) server, a mail server, a list server, a collaboration server and/or the like. In some embodiments, the server 120 can be operatively coupled to an application database 126 and a user database 128. The application database 126 can consist of data associated with a wide variety of applications that are executed on the patient devices 130, 160, and/or the healthcare provider device 140. The user database 128 can contain data associated with an individual user of the patient device 130 and/or 160, and/or the healthcare provider device 140. For example, the patient device 130, 160 can be associated with a patient and a record of the patient in the user database 128. The user database 128 can include patient records, such as medical records. Thus, the patient device 130, 160 can be associated with a record in the user database 128, which can include a record of the patient's medical history.

In some embodiments, the server 120 is configured to receive user authentication and/or user application requests from the patient device 130 and/or healthcare provider device 140, and generate user authentication data, application installation files, and application data in response to such requests. In some embodiments, server can be configured to associate the patient devices 130, 160 with patients. The server 120 can execute modules, processes and/or functions associated with such a health communication system 100.

The server has a prioritization module 125. The prioritization module 125 can be operable to prioritize patient care. For example, the server 120 can receive signals (e.g., including requests for patient care) from the patient device 130, 160 (via the network 110). The prioritization module 125 can be operable to prioritize requests for patient care based on, for example, an indication of urgency, and/or medical records associated with patients. For example, the prioritization module 125 can be operable to cross reference signals received from patient devices 130, 160 with the user database 128.

The prioritization module 125 can generate a list of tasks for caregivers, custodial staff, hospitality staff, etc., based, at least in part, on patient requests and patient medical records. The server can send the list of tasks, for example, to the healthcare provider device 140. The prioritization module 125 can dynamically update the list of tasks, for example as additional requests are received from the patient device 130, 160. The server 120 can send updated task lists to the healthcare provider device 140 as the updated task lists are generated.

Furthermore, in some embodiments, the server 120 can send signals to the patient device 130, 160 to cause the patient device 130, 160 to display an indication of when the patient will be visited, for example, by a caregiver, which can be in response to a request for medical attention. The prioritization module can be operable to estimate response time based on the number of tasks assigned to a caregiver, the caregiver's schedule, the caregiver's routine duties, the location of the caregiver, the location of the patient, etc. For example, the healthcare provider device 140 can include a GPS module (not shown), such that the server 120 can determine the location of the healthcare provider and/or the server 120 can be operable to determine the location of the patient based on a GPS module (not shown) of the patient device 130, 160, and or based on a hospital room assigned to the patient. The prioritization module 125 can be operable to determine the approximate arrival time based, for example, on the distance between the patient and the healthcare provider as well as based on the number of tasks prioritized before visiting the patient.

The server includes a distribution module 127. The distribution module 127 can be operable to send a prioritized task list to the healthcare provider device 140, e.g., via the network 110. Similarly, the distribution module 127 can be operable to send, to the patient device 130, 160, a response to requests for medical attention, which can include an indication of an expected response time and/or an indication of the caregiver assigned to respond to the request, as discussed in further detail herein.

The healthcare provider device 140 includes a processor 142, a memory 144, an input module 146, and an output module 148, each of which can be structurally similar to, the processor 132, the memory 134, the input module 136, and the output module 138 of the patient device 130, respectively. The healthcare provider device 140 can be associated with a healthcare provider, and can be operable to communicate with the server 120 and/or the patient device 130, 160 via the network. For example, the server 120 can send signals to the healthcare provider device 140 associated with patient care. In some embodiments, the server 120 can send signals to the healthcare provider device 140 to provide a healthcare provider with patient data, such as instructions for patient care, which can include an ordered list of tasks. In this way, the healthcare provider device 140 can provide instructions for nurse “rounding,” that is, instructions regarding which patients to visit, and, in some embodiments, in which order. For example, in response to receiving requests for medical attention, the server 120 can send instructions associated with the requests to the healthcare provider device 140. For example, the server 120 can send an ordered list of tasks to be performed by the healthcare provider to the healthcare provider device 140, which can include visiting and/or assisting patients. The order of the list of tasks can be based on, for example urgency of requests for medical attention and/or patient medical records. In some embodiments tasks responsive to patient requests can be dynamically inserted into a list including routine rounding tasks, such as administering medicine, repositioning patients, status checks, etc.

The healthcare provider can use the input module 136 of the healthcare provider device 140 to acknowledge the receipt of instruction, to confirm that instructions and/or tasks have been completed and/or the like. In some embodiments, the healthcare provider device 140 can be operable add tasks to the list of tasks. For example, while making rounds, a nurse may notice that a patient needs medical attention, but the nurse is not tasked with providing the attention. The nurse can use the healthcare provider device 140 to indicate the need for medical attention, which can be similar to requesting medical attention with the patient device 130, 160, as discussed in further detail herein. Using the healthcare provider device 140 to input a request for medical attention can include providing an indication of the patient in need of the medical attention (e.g., patient name, room number, patient ID, etc.) In some embodiments, the healthcare provider can indicate the need for medical attention and acknowledge the medical attention has been received. In this way, the server 120 can be operable to monitor healthcare provider productivity and/or status. For example, a healthcare facility can require that all patient care be documented using the healthcare provider device 140. If the healthcare provider completes a patient care task that was not included on the list of tasks sent to the healthcare provider device 140, the healthcare provider can add a task to the list of tasks by, for example, using the input module 146 of the healthcare provider device 140.

The healthcare provider device 140 can be operable to re-order the list of tasks. For example, after receiving a list of tasks, the healthcare provider can review the tasks, and, using, for example, the input module 146, rearrange the order of the tasks. The healthcare provider device 140 can be operable to send a signal to the server 120 indicating that the tasks have been re-ordered by the healthcare provider device 140. The server 120 can be operable to approve or deny the re-ordering. In some embodiments, the healthcare provider can only re-order tasks having the same priority, or a priority below a certain threshold. For example, in an embodiment where tasks are assigned a priority between 1 (highest) and 10 (lowest), the healthcare provider may be able to re-order any tasks with a priority between 4 and 10. In this way, the healthcare provider device 140 can cause high priority (e.g., emergency) tasks to be performed before low priority tasks, but the healthcare provider can re-order lower priority tasks as convenient.

In some embodiments, there can be more than one healthcare provider device. Each healthcare provider device can be assigned to and associated with a different healthcare provider. The server 120 can be operable to associate each healthcare provider device with a type of healthcare provider. For example, the server 120 can be operable to distinguish between and/or uniquely identify a healthcare provider device of a nurse, a healthcare provider device of an orderly, a healthcare provider device of a doctor, etc.

The server 120 can be operable to assign different tasks to different healthcare provider devices based on, for example, the role and/or responsibility of the healthcare provider associated with the healthcare provider device. For example, the server 110 can be operable to send a signal to a healthcare provider device associated with an orderly to instruct the orderly respond to a patient request for assistance taking a walk, and the server 110 can be operable to send a signal to a healthcare provider device associated with a nurse to instruct the nurse to respond to a patient request for attention associated with pain. In some embodiments, the server 120 can be operable to send a common task list to more than one healthcare provider device 140. In such an embodiment, when a healthcare provider completes a task on the common task list, the healthcare provider can confirm that the task has been completed (e.g., using the input module 146 of the healthcare provider device 140). The healthcare provider device 140 can be operable to send a signal indicating the task has been completed to the server 120. The server 120 can dynamically update the common task list on the other healthcare provider devices, indicating that the task has been completed, such that other healthcare providers are not instructed to duplicate the task.

The server 120 and/or the patient device 130, 160 can be operable to periodically verify that a communication link exists and is functional between the server 120 and the patient device 130, 160. Similarly stated, the server 120 and/or the patient device 130, 160 can verify that the patient device 130, 160 is connected to the network 110 and operable to communicate with the server 120. In some embodiments, the patient device 130, 160 can be configured to send periodic signals to the server 120 to verify the communication link. If the server 120 does not receive a periodic status signal from a patient device 130, 160, the server 130 can determine that there is an issue with the communication link with that patient device 130, 160. In this way, the server 120 can be operable to detect if the communication link between the patient device 130, 160 and the server “times out,” for example as a result of a power (e.g., battery) failure of the patient device 130, network 110 failure (e.g., lost wireless network signal), and/or the like. In the event the communication link fails, the server 120 can be operable to assign a task to a healthcare provider and/or an information technology professional to determine why the patient device 130, 160 is offline. In this way, if the patient device 130, 160 fails, the server 120 can assign a healthcare provider to visit the patient to minimize the risk that the patient will be without a way of requesting medical attention. Similarly, if the patient requires medical attention, but the patient device 130, 160 has failed, the patient can be assured that a healthcare provider is assigned to visit the patient to determine the cause of the failed patient device 130, 160. During such a visit, the patient can communicate the request for medical attention to the healthcare provider.

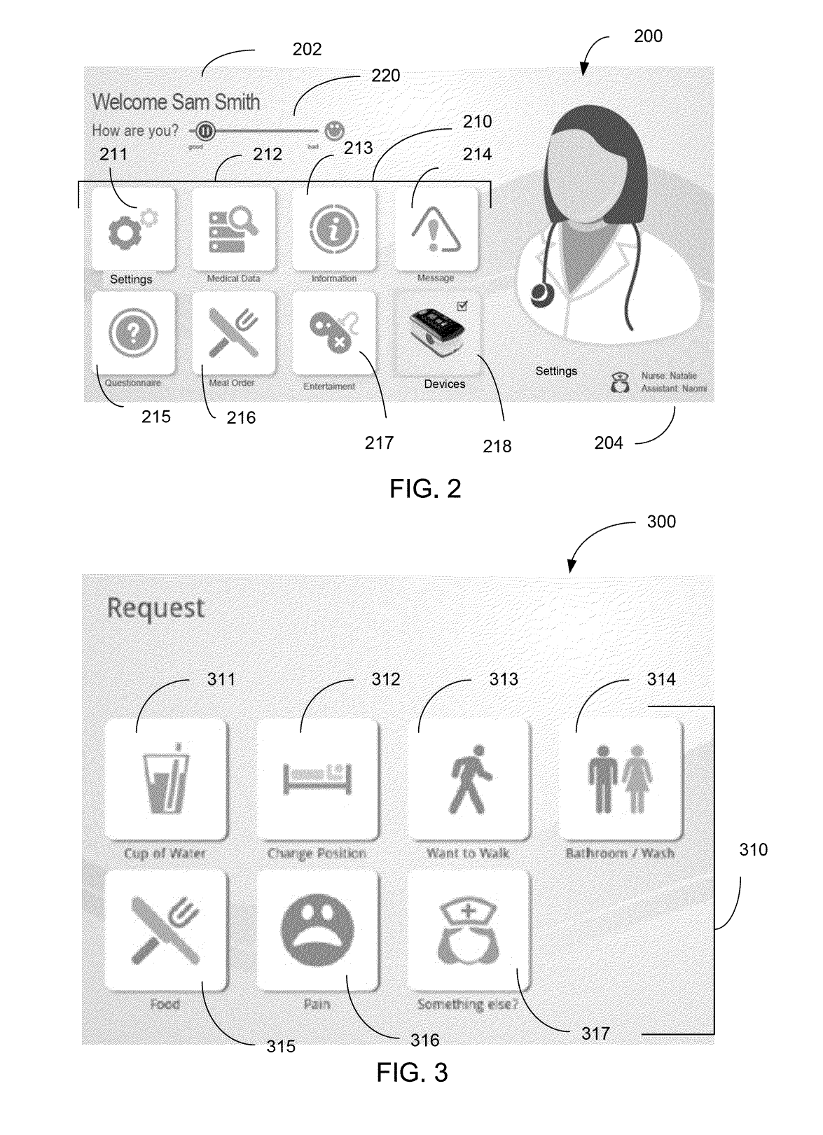

FIGS. 2 and 3 are screenshots of instances of a graphical user interface (GUI) of a patient device (e.g., the patient device 130, 160 as shown and described above with reference to FIG. 1). FIG. 2 depicts a welcome screen 200. The welcome screen 200 includes a status indicator 220, several icons 210, an indication of the patient's name 202, and an indication of a nurse and an assistant assigned to the patient 204.

The indication of the patient's name 202 and/or the indication of the nurse and the assistant assigned to the patient 204 can be used to personalize the welcome screen 200 for an individual user (e.g., a patient). The patient device can be operable to personalize the welcome screen 200 by, for example, registering with a server (e.g., the server 120 as shown and described above with reference to FIG. 1). The patient device can, prior to personalizing the welcome screen 200, request information associated with the patient, such as the patient's name, user name, identification number, and/or any other suitable information. The patient device can register with the server by sending an indication associated with the user to the server. In some embodiments, the patient can be asked to agree to terms and/or conditions before the patient device displays the welcome screen 200 and/or otherwise provides information to the patient. The server can send information associated with the patient, e.g., from a patient database, to the patient device, such that the welcome screen 200 can be personalized with, for example, the patient's name 202, the patient's nurse and assistant nurse 204, and/or any other suitable information about the patient's individualized care.

The icons 210 include a settings icon 211, a medical data icon 212, an information icon 213, a message icon 214, a questionnaire icon 215, an entertainment icon 217 and a device icon 218. Each icon 210, when selected, can be operable to cause an associated module to be executed (e.g., on a processor such as the processor 132, 162). Such modules can cause the patient device to display information, receive a user input, and/or send signals, for example, to a server.

The settings icon 211, when selected, can cause a settings module to execute (on a processor). Such a settings module can be operable to allow the patient to alter the patient device's settings. For example, after selecting the settings icon 211, the patient device can display, for example, a GUI, a menu, etc., which can display and/or enable the user to change the patient device's settings. For example, after selecting the settings icon 211, the patient can alter the device's screen brightness, font size, icon size, etc.

The medical data icon 212, when selected, can cause a medical data module to execute (on a processor). Such a medical data module can be operable to cause the patient device to display, for example, medical data and/or the results of medical tests. For example, when the medical data icon 212 is selected, the patient device can be operable to access medical data and/or send a signal to a server to request medical data. The patient device can then receive and/or display medical data associated with the patient.

The information icon 213, when selected, can cause an information module to execute (on a processor). Such an information module can be operable to cause the patient device to display general information (e.g., regarding the care facility, the patient device, etc., and/or personalized information, such as information regarding the user's status, condition, treatment, etc.). For example, when the information module 213 is selected, the patient device can display drug and/or disease fact sheets, information regarding visiting hours, etc. In some embodiments, the patients can select informational documents from a library of documents, and/or the healthcare provider can select a document from the library of documents to be pushed to the patient device.

The message icon 214, when selected, can cause a message module to execute (on a processor). Such a message module can be operable to cause the patient device to display messages between a healthcare provider and the patient. For example, the patient device can be operable to receive messages from the caregiver staff, which can be accessed by the patient. Receiving messages can be similar to receiving email, instant messages (IM), and/or short message service (SMS) messages. In some embodiments, the patient device can enable the patient to send messages to the staff of the care facility. Furthermore, the notification can be configured to be “insisting” and behave like an alarm clock, including the ability to view messages, dismiss messages and to “snooze” for a configured amount of time before reappearing. In some embodiments, the patient and/or the healthcare provider can send and/or receive messages via, for example, voice over internet protocol (VOIP) voicemail messages and/or VOIP transcription.

The questionnaire icon 215, when selected, can cause a questionnaire module to execute (on a processor). Such a questionnaire module can be operable to cause the patient device to display a questionnaire, survey, form, etc. For example, the patient can use the patient device to fill out surveys regarding his medical history, contact information, intake form, experience, satisfaction, etc. The patient device can be operable to transmit the surveys to, for example, the server. The server, in some embodiments, can be operable to associate survey results with, e.g., patient data, such as medical records. In some embodiments, the server can send surveys to the patient device (where they can be accessed by the patient by selecting the questionnaire icon 215) as additional data is needed and/or requested, e.g., requested by a caregiver. In some embodiments, the patient device can be operable to present video surveys, e.g., surveys including questions and/or responses recorded in a video message.

The meal order icon 216, when selected, can cause a meal order module to execute (on a processor). Such a meal order module can be operable to allow the patient to order a meal using the patient device. For example, accessing the meal order icon 216 can cause an interactive menu to be displayed. Using the interactive menu, the patient can select a meal. The selection can be sent to a cafeteria and/or other food service provider (e.g., via the server) for fulfillment. In some embodiments, the interactive menu can be operable to interact with patient data, such as medical records, such that the menu is personalized for the patient. For example, if the patient's medical record indicates a peanut allergy, the interactive menu can disable the option to order a peanut butter and jelly sandwich. Similarly, if the patient's caregiver has the patient on a restricted diet, e.g., low fat, certain menu options can be disabled, e.g., hamburger.

For example, the server can include a database of menu options, each of which can be associated with a number of parameters, such as ingredients, caloric content, nutritional information, etc. The patient and/or the healthcare provider can provide an indication, e.g., in the patient's medical data, operable to flag and/or disable certain dietary options. In this way, the patient device can interact with the database of menu options and the patient data to flag and/or disable meal options. As an example, a patient may provide an indication that he will only eat kosher food, while a healthcare provider may provide an indication that the patient should not be given food containing more than 2 g of saturated fat or food containing soy. Accordingly, the patient device 130 and/or the server 120 can be operable to disable the selection of, for example a hamburger (too much fat), spring rolls (contains soy, not kosher), a ham sandwich (not kosher), etc. Similarly stated, in some embodiments, a module, such as the meal order module (e.g., on the patient device 130 and/or the server 120) can be operable to prevent the sending of a signal based on the medical record of the patient.

The entertainment icon 217, when selected, can cause an entertainment module to executed (on a processor). Such an entertainment module can be operable to cause the patient device to display entertainment options, such as video game options, ebook reader, internet access, etc. In some embodiments, such a module can be operable to cause the patient device to function as a remote control, for example for a television in the patient's room.

The devices icon 218, when selected, can cause a device module to execute (on a processor). Such a device module can be operable to cause the patient device to display indicators associated with various devices. For example, the patient device can be operable to be communicatively coupled to various medical instruments, such as an oximeter, a scale, a blood pressure monitor, a thermometer, an electrocardiogram, etc. In some embodiments, the patient device can be coupled to a device via, for example, a universal serial bus connection, Bluetooth™, the server via the network, and/or any other suitable connection. In some embodiments, the patient device can be operable to collect data from medical devices and send a signal to report the data to a healthcare provider, e.g., via the server. In some embodiments, the patient device can be operable to display medical data when the devices icon 218 is selected. The patient device can show trends and/or alerts, which may aid the patient in managing his care.

The status indicator 220 can be operable to allow the user to provide an indication of his condition. For example, the status indicator 220 can be a slider that the user can use to indicate his comfort/pain level on a scale. For example, the status indicator 220 can be a “pain face” scale displayed prominently at the top of the welcome screen 200. The status indicator 220 can give the patient the ability to continuously indicate how he is doing. The status indicator 220 can be operable to send alerts (e.g., to the server) in response to various inputs, e.g., if the patient lowers the status indicator 220, if the patient routinely has a low status, etc.

FIG. 3 depicts a request screen 300. The request screen includes several icons 310, each of which, when selected can be operable to cause a module to be executed (e.g., on a processor) and/or a signal to be sent from the patient device (e.g., to a server). As shown, the request screen 300 includes icons 310 for requesting a cup of water 311, requesting a change of position 312, requesting to go for a walk 313, requesting assistance to use the bathroom 314, requesting food 315, indicating pain 316, and requesting something else 317. The patient device can be operable to send signals, e.g., to the server, when an icon 310 is selected. In some embodiments, the patient device can be operable to send an indicator of an urgency when an icon 310 is selected. For example, when the pain icon 316 is selected, the patient device can send a signal including an indication of high urgency, while when the go for a walk icon 313 is selected, the patient device can send a signal including an indication of low urgency. In some embodiments, the patient device can be operable to prompt the patient to select an urgency when sending a request for medical attention. For example, if the patient selects the bathroom icon 314, the patient device can prompt the patient to indicate a level of urgency associated with the request.

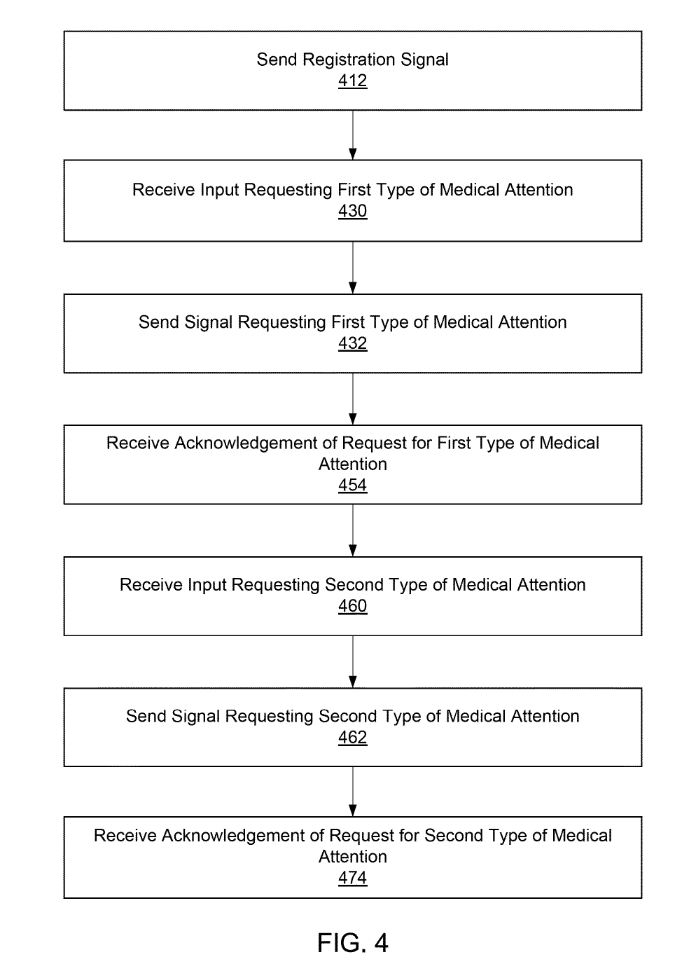

FIG. 4 is a flow chart of a method of operating a patient device (e.g., the patient device 130, 160 as shown and described above with reference to FIG. 1), according to an embodiment. The patient device can send a registration signal, at 412. The registration signal can include an indication of the patient using the patient device, such as the patient's name, patent identifier (ID) (e.g., social security number, patient number, etc.), and/or other suitable indicator. The patient device can send the registration signal to a server (e.g., the server 120). The registration signal sent, at 412, can be operable to allow the server to associate the patient device with the patient (e.g., associate a patient device identifier with the patient within a memory accessible by the server.

The patient device, can be operable to enable the patient to request medical attention. The patient device can be operable to allow the patient to request various types of medical attention, for example, as shown and described above with reference to FIG. 3. The patient device can be operable to receive an input from the patient, at 430, associated with a request for a first type of medical attention.

At 432, the patient device can send a signal, for example, to the server, requesting the first type of medical attention. The server can receive the signal requesting medical attention, and based on the association of the patient device with the patient (e.g., within the memory accessible by the server), the server can associate the request for medical attention with the patient.

The patient device can receive a response, e.g., from the server, acknowledging the request for medical attention, at 454. The acknowledgement can include an indication of an expected response time. The server can assign a caregiver to respond to the request based on the type of medical attention requested. For example, if the first type of request is a request for assistance to use the restroom or take a walk, the server can assign, to an orderly, a task to visit the patient to assist the patient with the request. The server can be operable to calculate and send, and the patient device can be operable to receive, an indication of the expected response time. The server can be operable to manage the assignments of healthcare providers. For example, each healthcare provider can be assigned a healthcare provider device (e.g., the healthcare provider device 140), such that the server can manage the responsibilities of each healthcare provider. For example, the server can be operable to estimate the response time based on the priority assigned to the request, the other tasks assigned to the caregiver, the number of requests received from the patient and/or other patients, the location of the caregiver and/or the patient, etc. Thus, the server can be operable to estimate the response time for delivering the first type of medical attention requested, at 432, and can include an indication of the response time in the acknowledgement, at 454.

The patient device can be operable to receive an input from the patient, at 460, associated with a request for a second type of medical attention. For example, the patient device can send an indication that the patient is in pain.

At 462, the patient device can send a signal, e.g., to the server, requesting the second type of medical attention. Requesting the second type of medical attention, at 462 can be similar to requesting the first type of medical attention, at 432.

The patient device can receive a response, e.g., from the server, acknowledging the request for medical attention, at 474. The acknowledgement can include an indication of an expected response time. As described above with reference to receiving the acknowledgement of the request for the first type of medical attention, at 454, the server can send, and the patient can receive an indication of the response time, at 474. For example, if the second type of request is an indication that the patient is in pain, the server can assign a nurse a task to visit the patient to determine whether to administer a painkiller. Similarly stated, the server can be operable to assign the appropriate caregiver based on the type of medical attention requested. For example, the patient device can receive an input from the patient, at 430, 460, requesting, for example, a meal, flowers, assistance using the restroom, and/or the like. In response to the patient device sending the request, at 432, 462, the server can assign an appropriate healthcare provider, for example, a cafeteria worker, a gift shop worker, an orderly and/or the like. The server can be operable to send, and the patient device can be operable to receive, at 454, 474, a signal including an indication of the assigned healthcare provider and/or an estimate of the response time.

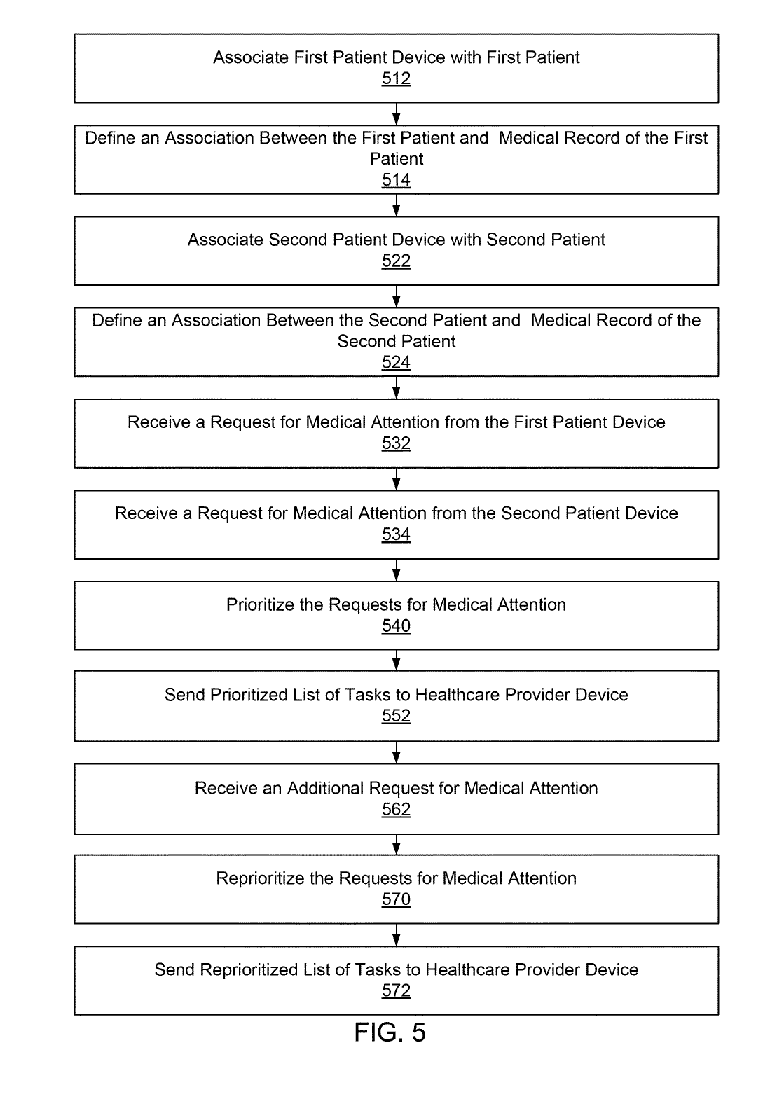

FIG. 5 is a flow chart of a method of managing patient care, according to an embodiment. At 512, a first patient device (e.g., the first patient device 130 as shown and described above with reference to FIG. 1) is associated with a first patient. For example, a server (e.g., the server 120) can receive a registration signal from a first patient device including an identifier associated with the patient, for example, at 412, as described above with reference to FIG. 4. The server can then be operable to register the first patient device, such that the server can associate signals received from the first patient device with the first patient.

The first patient and/or the first patient device can be further associated with medical records of the first patient, at 514. For example, the server can include and/or have access to a database of medical records. The server can be operable to cross reference signals received from the first patient device with patient medical records.

Similarly, the server can be operable to register any number of patient devices. For example, the server can associate a second patient device (e.g., the second patient device 160) with a second patient, at 522, and define an association between the second patient and a medical record of the second patient, at 524 (e.g., associate a patient device identifier with the patient and her associated medical record within a memory accessible by the server).

The server can receive a request for medical attention from the first patient device, at 532. For example, as shown and described above with reference to FIG. 4, the first patient can provide an input to the first medical device to request medical attention (e.g., at 430, 460) and the first medical device can be operable to send a signal to the server (e.g., at 432, 462).

Similarly, the server can receive a request for medical attention from the second patient device, at 534.

The server can be operable to prioritize the requests for medical attention, at 562. For example, the server can determine how to respond to the request for medical attention, can generate an ordered list of tasks for responding to the requests, and/or, can assign tasks to caregivers. For example, the server can cross reference the request for medical attention, which can include an indication of a particular type of medical attention requested, with medical records, history of patient requests, staffing availability, etc. The server can assign an urgency to a request and/or a caregiver to respond to the request. For example, a request indicating the patient is in pain can be assigned a higher priority than a request for a meal, and/or a request received from a patient with a more serious (e.g., critical) medical condition can be prioritized over a request received from a patient with a less serious (e.g., less critical) medical condition. Similarly, a request indicating the patient is in pain can be assigned to a licensed care provider (e.g., a nurse, doctor, etc.) while a request for a meal can be assigned to an orderly and/or transmitted directly to the cafeteria. In some embodiments, the server can be operable to send an acknowledgement signal to the requesting patient, which can include an indication of an expected response time.

The server can send a prioritized list of tasks to a healthcare provider device, at 562. For example, the server can be operable to manage nurse rounding. In some embodiments, the server can send a prioritized list of tasks to a plurality of healthcare provider devices. For example, the server can be operable to assign task lists and rounding schedules to one or more nurses, doctors, orderlies, facilities personnel, hospitality staff, cafeteria workers, etc. The server can send a list of patients to visit, tasks to be performed (e.g., assist patient taking a walk, prepare patient lunch, inquire as to patient's pain, and/or the like).

The server can be operable to dynamically update the priority of one or more tasks. For example, the server can receive an additional request for medical attention, at 562. For example, the server can receive a request for medical attention from the first patient device, the second patient device, or a third patient device after having prioritized the requests, at 540.

Based on the additional request received, at 562, the server can be operable to reprioritize the requests for medical attention, at 570. For example, the server can decrease the priority of previously prioritized tasks, can add new tasks, and/or can reorder the list of tasks associated with a healthcare provider device (e.g., the healthcare provider device 140). The server can then send the reprioritized list of tasks to the healthcare provider device, at 572. Similarly stated, the server can be operable to send signals to the healthcare provider device to update the healthcare provider's task list as additional requests for medical attention are received. The updates can be operable to cause the healthcare provider device and/or the server to reorder the task list, as described above.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

While various embodiments have been described above, it should be understood that they have been presented by way of example only, and not limitation. For example, although various embodiments herein describe a patient device for use in a healthcare facility, in other embodiments, the patient device can be used in a home-care setting. For example, the patient device can be operable to interface with various at-home medical monitoring equipment, such as a scale and/or a blood pressure monitor, such that a monitoring provider (e.g., the patient's primary care physician, a nurse, and/or the patient's insurance carrier) can access and review the patient's at-home testing and/or respond to deviations and/or alarms associated with at-home monitoring. Furthermore, although some embodiments described the healthcare provider responding to patient-initiated requests for medical attention, in some embodiments, the server and/or the patient device can be operable to automatically request medical attention, for example, based on results of patient monitoring.

Where methods described above indicate certain events occurring in certain order, the ordering of certain events may be modified. Additionally, certain of the events may be performed concurrently in a parallel process when possible, as well as performed sequentially as described above. For example, although FIG. 5 shows and is described requests for medical attention, at 540 as occurring after receiving a request for medical attention from the first patient, at 532, and a request for medical attention from the second patient, at 532, in other embodiments, the server can be periodically and/or constantly monitoring for requests for medical attention and prioritizing requests, as they are received.

Where schematics and/or embodiments described above indicate certain components arranged in certain orientations or positions, the arrangement of components may be modified. While the embodiments have been particularly shown and described, it will be understood that various changes in form and details may be made.

Although various embodiments have been described as having particular features and/or combinations of components, other embodiments are possible having a combination of any features and/or components from any of embodiments as discussed above. For example, although the requests for medical attention shown and described in reference to FIG. 5 do not include an indication of the type of medical attention requested, e.g., as shown and described in FIG. 4, in other embodiments, the requests for medical attention of FIG. 5 can include an indication of the type of medical attention requested.

What is claimed is:

1. An apparatus, comprising:
a prioritization module implemented in at least one of a memory or processing device,
the prioritization module configured to receive, from a patient device associated with a patient, a signal associated with a task and having an urgency indicator,
the prioritization module configured to generate a list having identifiers associated with a plurality of tasks including the task, the task from the plurality of tasks associated with visiting the patient, the prioritization module configured to order the plurality of tasks based, at least in part, on the urgency indicator,
the prioritization module configured to send, to a caregiver device, the list.

2. The apparatus of claim 1, wherein:
the patient is a first patient, the urgency indicator is a first urgency indicator, the task is a first task,
the prioritization module is configured to receive, from a patient device associated with a second patient, a signal associated with a second task from the plurality of tasks and having a second urgency indicator,
the second task associated with visiting the second patient,
the prioritization module configured to order the plurality of tasks based, at least in part on the second urgency indicator.

3. The apparatus of claim 1, wherein the prioritization module is configured to order the plurality of tasks based, at least in part, on a medical record associated with the patient.

4. The apparatus of claim 1, wherein:
the patient is a first patient, the urgency indicator is a first urgency indicator, the task is a first task from the plurality of tasks,
the prioritization module is configured to receive, from a patient device associated with a second patient, a signal associated with a second task from the plurality of tasks and having a second urgency indicator,
the prioritization module configured to order the plurality of tasks based, at least in part on a medical record of the first patient and a medical record of the second patient.

5. The apparatus of claim 1, wherein the signal is associated with at least one of: (1) a medical condition of the patient, (2) a request for attention from a caregiver, (3) a request for attention from a hospitality staff member, (4) results of a medical test, or (5) a meal order.

6. A non-transitory processor-readable medium storing code representing instructions to be executed by a processor, the code comprising code to cause the processor to:
associate a first patient device with a first patient;
define an association between the first patient device and a medical record of the first patient;
associate a second patient device with a second patient;
receive a request for medical attention from the first patient device;
receive a request for medical attention from the second patient device;
prioritize the request for medical attention from the first patient device over the request for medical attention from the second patient device based, at least in part, on the medical record of the first patient; and
send, to a healthcare provider device, the request for medical attention from the first patient device and an indication of a priority of the request for medical attention from the first patient device.

7. The non-transitory processor-readable medium of claim 6, further comprising code configured to cause the processor to:
define an association between the second patient device and a medical record of the second patient, the medical record of the first patient including an indication of a first condition, the medical record of the second patient including an indication of a second condition, the first condition being more critical than the second condition.

8. The non-transitory processor-readable medium of claim 6, further comprising code configured to cause the processor to:
define an association between the second patient device and a medical record of the second patient, the code to cause the processor to prioritize includes code to cause the processor to prioritize based, at least in part, on the medical record of the second patient.

9. The non-transitory processor-readable medium of claim 6, wherein the request for medical attention from the second patient device is a request for a type of medical attention, the code to cause the processor to prioritize includes code to cause the processor to prioritize based, at least in part, on the type of medical attention.

10. The non-transitory processor-readable medium of claim 6, the code further comprising code to cause the processor to:
associate a third patient device with a third patient;
define an association between the third patient device and a medical record of the third patient;
receive a request for medical attention from the third patient device after prioritizing the request for medical attention from the first patient device over the request for medical attention from the second patient device;
prioritize the request for medical attention from the first patient device under the request for medical attention from the third patient device based, at least in part on the medical record of the third patient; and
send, to the healthcare provider device the request for medical attention from the third patient device and an indication of a priority of the request for medical attention from the third patient device.

11. The non-transitory processor-readable medium of claim 6, the code further comprising code to cause the processor to:
associate a third patient device with a third patient;
receive a request for a medical attention from the third patient device after prioritizing the request for medical attention from the first patient device over the request for medical attention from the second patient device, the request for medical attention from the third patient device a request for a type of medical attention;
prioritize the request for medical attention from the first patient device under the request for medical attention from the third patient device based, at least in part on the type of medical attention requested by the third patient device; and
send, to the healthcare provider device the request for medical attention from the third patient device and an indication of a priority of the request for medical attention from the third patient device.

12. The non-transitory processor-readable medium of claim 6, wherein the request for medical attention from the second patient device is a first request for medical attention from the second patient device, the code further comprising code to cause the processor to:
receive a second request for medical attention from the second patient device after prioritizing the request for medical attention from the first patient device over the first request for medical attention from the second patient device; and
prioritize the request for medical attention from the first patient device under the second request for medical attention from the second patient device based, at least in part, on a number of requests received from the second patient device; and
send, to the healthcare provider device the second request for medical attention from the second patient device and an indication of a priority of the second request for medical attention from the second patient device.

13. The non-transitory processor-readable medium of claim 6, wherein the code to cause the processor to prioritize includes code to cause the processor to prioritize based, at least in part, on a number of requests for medical attention received from the second patient device.

14. A non-transitory processor-readable medium storing code representing instructions to be executed by a processor, the code comprising code to cause the processor to:
send a registration signal including an indicator associated with a patent to a server;
receive an input requesting a first type of medical attention;
send, in response to the input requesting the first type of medical attention, a signal requesting the first type of medical attention to the server such that the server sends a request to a first caregiver based on the first type of medical attention being requested;
receive, from the server and in response to the signal requesting the first type of medical attention, an indication of an expected response time associated with the first caregiver;
receive an input requesting a second type of medical attention; and
send, in response to the input requesting the second type of medical attention, a signal requesting the second type of medical attention to the server such that the server sends a request to a second caregiver based on the second type of medical attention being requested.

15. The non-transitory processor-readable medium of claim 14, wherein the signal requesting the first type of medical attention includes an indication of an urgency.

16. The non-transitory processor-readable medium of claim 14, the code further comprising code to cause the processor to:
receive, from the server and in response to the signal requesting the second type of medical attention, an indication of an expected response time associated with the second caregiver.

17. The non-transitory processor-readable medium of claim 14, wherein:
the signal requesting the first type of medical attention is associated with a first urgency level, the signal requesting the second type of medical attention is associated with a second urgency level different from the first urgency level.

18. The non-transitory processor-readable medium of claim 14, wherein the input requesting the first type of medical attention includes an indication of an urgency level.

19. The non-transitory processor-readable medium of claim 14, wherein the input requesting the first type of medical attention includes an indication of an urgency level, the expected time based, at least in part on the urgency level.

20. The non-transitory processor-readable medium of claim 14, wherein the expected time is based, at least in part, on a number of signals requesting medical attention sent to the server.

21. The non-transitory processor-readable medium of claim 14, the code further comprising code configured to cause the processor to receive a signal from the server associated with medical information.

22. The non-transitory processor-readable medium of claim 14, the code further comprising code to cause the processor to:
receive, from the server an indication of a medical record of the patient; and
prevent the sending of a signal requesting a third type of medical attention based on the medical record.
